(19) United States
(12) Patent Application Publication
(10) Pub. No.: US 2019/0208378 A1
(43) Pub. Date: Jul. 4, 2019

(54) SYSTEMS AND METHODS FOR MANAGING RESOURCE CONSUMPTION OF WIRELESS TELECOMMUNICATIONS

(71) Applicant: LOON LLC, Mountain View, CA (US)

(72) Inventors: Sharath Ananth, Mountain View, CA (US); Mitchell Trott, Mountain View, CA (US)

(21) Appl. No.: 15/858,182

(22) Filed: Dec. 29, 2017

(51) Int. Cl. H04W 4/24; H04L 12/14; H04W 24/08; H04W 4/20

(52) U.S. Cl. CPC H04W 4/24; H04L 12/1414; H04W 4/20; H04W 24/08; H04L 12/1432

(57) ABSTRACT

Systems and methods for managing resource consumption of wireless communication. An illustrative system includes a wireless transceiver, a wireless communications device in wireless communication with the wireless transceiver, a computing device communicatively coupled to the wireless transceiver, the computing device including a processor and a memory storing instructions which, when executed by the processor, cause the computing device to receive data regarding a data transfer between the wireless transceiver and the wireless communications device, compute an amount of resources associated with the data transfer, generate a notification based on the amount of resources, and transmit the notification to the wireless communications device.

### BACKGROUND

Facilitation of wireless communications, such as cellular telecommunications, require various resources, and the cost of the resources are often passed from the provider or facilitator to the user. The cost of hardware infrastructure, such as cellular transceivers and the equipment on which they are mounted, is typically considered capital expenditure and not directly passed on to the users. Instead, the traditional cost of wireless communications is calculated based on a particular user's use of the wireless communications infrastructure. That is, the user is typically billed based on the number of minutes of a wireless telephone call, a number of short or multimedia messages (SMS or MMS) sent and received by the user, and/or the amount of data transmitted and received via the wireless communications infrastructure, and in some instances, the speed or data rate of the data transfer. This traditional method of billing treats every minute of call-time used and every message and byte of data sent or received by every user as costing the same. However, in some circumstances, the cost of facilitating every minute of call-time used and every message and byte of data sent or received by the user is not the same, and may in fact vary greatly based on various mechanical and/or environmental factors. The present disclosure provides systems and methods for managing resource consumption of wireless telecommunications and/or billing users based on resources consumed to facilitate the particular wireless communication used.

### SUMMARY

In one aspect, this disclosure describes a system for managing resource consumption of wireless communication. In embodiments, the system includes a wireless transceiver, a wireless communications device in wireless communication with the wireless transceiver, a computing device communicatively coupled to the wireless transceiver, the computing device including a processor and a memory storing instructions which, when executed by the processor, cause the computing device to receive data regarding a data transfer between the wireless transceiver and the wireless communications device, compute an amount of resources associated with the data transfer, generate a notification based on the amount of resources, and transmit the notification to the wireless communications device.

In embodiments, the instructions, when executed by the processor, further cause the computing device to calculate a cost of the amount of resources associated with the data transfer.

In embodiments, the instructions, when executed by the processor, further cause the computing device to provide a notification to the wireless communications device regarding the calculated cost of the amount of resources associated with the data transfer.

In embodiments, the resources include energy.

In embodiments, the system further includes an energy source coupled to the wireless transceiver, the energy source being configured to provide energy to the wireless transceiver.

In embodiments, the instructions, when executed by the processor, further cause the computing device to receive data regarding an amount of energy consumed to facilitate the data transfer, wherein the computation of the amount of resources associated with the data transfer is at least partially based on the data regarding the amount of energy consumed to facilitate the data transfer.

In embodiments, the instructions, when executed by the processor, further cause the computing device to provide a notification to the wireless communications device regarding the amount of energy consumed to facilitate the data transfer.

In embodiments, the instructions, when executed by the processor, further cause the computing device to determine a signal strength of a connection between the wireless transceiver and the wireless communications device.

In embodiments, the instructions, when executed by the processor, further cause the computing device to provide a notification to the wireless communications device regarding the signal strength of the connection between the wireless transceiver and the wireless communications device.

In embodiments, the computation of the amount of resources associated with the data transfer is at least partially based on the signal strength of the connection.

In embodiments, the notification is a textual message.

In embodiments, the notification is a graphical element.

In embodiments, the notification is color-coded.

In embodiments, the notification includes color-coded signal bars.

In embodiments, the notification includes guidance for improving the signal strength of the connection.

In embodiments, the notification is provided during the data transfer.

In embodiments, the notification is provided after the data transfer.

In embodiments, the data regarding a data transfer includes at least one of an amount of data transferred, a data transfer rate, a duration of the data transfer, or a type of data transfer.

In another aspect, the present disclosure describes a method for managing resource consumption of wireless communications. In embodiments, the method includes receiving data regarding a data transfer between a wireless transceiver and a wireless communications device, computing an amount of resources associated with the data transfer, generating a notification based on the amount of resources, and transmitting the notification to the wireless communications device.

In another aspect, the present disclosure describes a non-transitory computer-readable storage medium storing a program for managing resource consumption of wireless communications, the program including instructions which, when executed by a processor, cause a computing device to receive data regarding a data transfer between a wireless transceiver and a wireless communications device, compute an amount of resources associated with the data transfer, generate a notification based on the amount of resources, and transmit the notification to the wireless communications device.

### BRIEF DESCRIPTION OF THE DRAWINGS

Various aspects and features of the present systems and methods for managing resource consumption of wireless telecommunications are described herein below with references to the drawings, wherein:

FIG. 1 is a schematic diagram of an illustrative wireless telecommunication system, in accordance with an embodiment of the present disclosure;

FIG. 2 is a schematic diagram showing additional aspects of the wireless telecommunication system of FIG. 1, in accordance with an embodiment of the present disclosure;

FIG. 3 is a schematic block diagram of an illustrative embodiment of a computing device that may be employed in various embodiments of the present system, for instance, as part of the system or components of FIG. 1 or 2, in accordance with an embodiment of the present disclosure;

FIG. 4 is a flowchart showing an illustrative method for providing notifications regarding costs of wireless telecommunications from the perspective of a computing device of FIG. 1, in accordance with an embodiment of the present disclosure; and

FIG. 5 is a flowchart showing an illustrative method for calculating costs of wireless telecommunications from the perspective of the computing device of FIG. 1, in accordance with an embodiment of the present disclosure.

### DETAILED DESCRIPTION

The present disclosure is directed to systems and methods for managing resource consumption of wireless telecommunications. More specifically, the systems and methods of the present disclosure, by means of one or more computing devices, calculate a cost of a wireless communication session based the resources consumed to facilitate the wireless communication session, and provides the user of a wireless communication device (hereinafter referred to as “user equipment” abbreviated “UE”) with real-time notifications regarding the cost of the wireless communication session, as further described below. The computing devices and/or the UE may further provide the user with real-time guidance regarding cost expectations and/or ways to mitigate excessive costs for wireless communications based on the location of the UE and/or the wireless communications infrastructure (referred to hereinafter as “wireless infrastructure” or simply “the infrastructure”), as further described below.

At any given time, the resources required to facilitate wireless communications, such as data transfer, between a wireless transceiver and a UE is correlated to the signal strength of the connection between the UE and the wireless transceiver. For example, when the signal strength of the connection between the UE and the wireless transceiver is strong, less energy is required to facilitate data transfer than when the signal strength of the connection is weak. The energy cost for facilitating data transfer is thus roughly inversely correlated to the signal strength of the connection between the UE and the wireless transceiver.

Signal strength may vary based on a variety of factors, including the distance between the UE and the wireless transceiver, the amount and type of obstructions in the signal path between the UE and the wireless transceiver, weather conditions, other wireless or RF signal interference, etc. While the user of the UE may not have control over the weather and, in some cases, the distance between the UE and the wireless transceiver, the user may be able to move the UE to a more favorable location, e.g., an area with less interference or obstructions between the UE and the wireless transceiver, to thereby reduce the resource cost of the data transfer.

The cost of a wireless communications session is determined not only based on the number of minutes of call-time used and/or messages and bytes of data transmitted or received by the UE during the wireless communications session, but also based the cost of resources consumed to facilitate the wireless communications session. In some embodiments, the cost of the wireless communications session is determined only based on the cost of resources consumed to facilitate the wireless communications session, while in other embodiments a hybrid calculation is used to determine the cost of the wireless communications session based on both the number of minutes of call-time used and/or messages and bytes of data transmitted or received by the UE during the wireless communications session as well as the cost of resources consumed to facilitate the wireless communications session. In still further embodiments, both cost calculations, i.e. the traditional calculation of cost based on the number of minutes of call-time used and/or messages and bytes of data transmitted or received by the UE, and the calculation of the cost of the resources consumed to facilitate the wireless communications session, and the user may be billed based on the traditional calculation with credits and/or refunds given if the cost of the resources consumed to facilitate the wireless communications session is below a predetermined threshold. For example, the user may be billed at a standard rate based on the traditional cost calculation, and may then be given credit if the cost of resources consumed to facilitate a wireless communications session is less than a predetermined amount. Alternatively, the user may be given credit after a period of time, such as a day, week, or month, if the average cost of resources consumed to facilitate all the user's wireless communications sessions within that period is less than a predetermined amount. In this way, the user may be incentivized to attempt to reduce the cost of resources consumed to facilitate the user's wireless communications when possible.

The general idea is that, by providing the user with an indication of how much resources is being consumed to facilitate wireless telecommunications at the user's particular location, the user is enabled to change their behavior (e.g., change their location to a location at which the wireless transceiver is providing better signal coverage and therefore would consume less resources to provide wireless telecommunications, disable data communication to minimize usage while in poor coverage areas, etc.) to make more efficient usage of the wireless infrastructure's resources.

The resources consumed to facilitate wireless communications may be dependent on the type of wireless infrastructure used to provide wireless communications service. For terrestrial-based wireless infrastructure, the resources generally include energy to power electrical components of the infrastructure, such as terrestrial base stations, and wireless spectrum usage over a particular period of time. Alternatively or in addition, the resources may include time/frequency resources, such as an amount of spectrum over an amount of time. For example, in embodiments where a wireless transceiver uses a fixed amount of energy to communicate over a particular wireless frequency over a particular period of time, the cost of the energy and the cost of the wireless spectrum usage may become substantially equivalent. Energy includes not only transmitted energy, e.g. the energy used to generate the wireless signal, but also energy consumed in the electronics associated with transmission chains in the transceiver, such as digital to analog converters, mixers, multi-antenna beam forming systems, and baseband and other computations performed by one or more computing devices forming part of or associated with the wireless infrastructure.

Additionally, for wireless infrastructure systems where energy is limited, for example, wireless infrastructure systems that are not connected to an always-on power grid, the cost of the energy itself may not be consistent. For example, if the wireless infrastructure relies on a solar power source for energy, the cost of energy during times when the solar power source is not generating energy may be higher than during times when the solar power source is generating energy. Additionally or alternatively, the cost of energy in limited-energy systems may be dependent on the amount of energy remaining in a power storage module, such as a battery. For example, the cost of energy may increase as the amount of energy remaining decreases. By making the user of a UE connected to wireless infrastructure with limited power aware of a current energy cost and the reason why energy costs are higher at particular times, the user may change their behavior so as to use less wireless communications, and thus consume less energy, during times when energy costs are higher, and instead favor times when energy costs are lower. These and other advantages of the systems and methods of the present disclosure will become apparent to those skilled in the art based on the following description of the drawings.

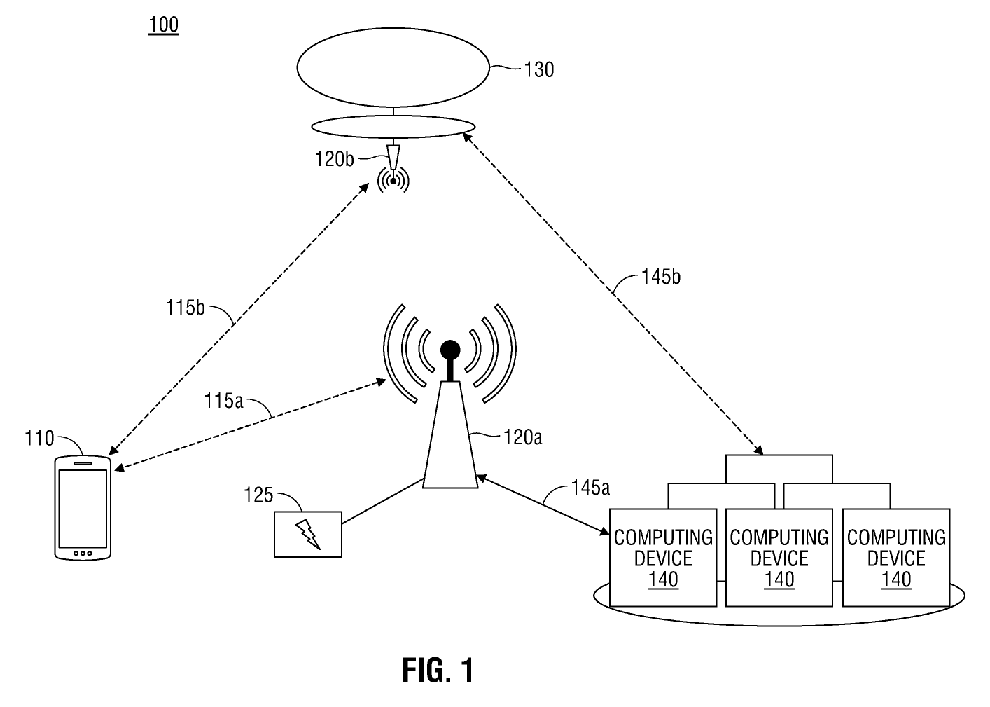

With reference to FIG. 1, an illustrative wireless telecommunications system 100 generally includes a user equipment device (UE) 110, one or more wireless transceivers 120a, 120b (referred to collectively as wireless transceivers 120), and one or more computing devices 140. The UE 110 is at least periodically in wireless communication with the one or more wireless transceivers 120 via wireless communication links 115a, 115b. Likewise, the wireless transceivers 120 are at least periodically in wired and/or wireless communication with the computing devices 140 via communication links 145a, 145b. The wireless transceivers 120 may include one or more terrestrial wireless transceivers 120a, such as cellular towers or antennae coupled to terrestrial structures, and/or one or more aerial wireless transceivers 120b, such as transceivers coupled to one or more aerial vehicles 130. The wireless transceivers are further coupled to an energy source 125 (shown in FIG. 1 as coupled to the wireless transceiver 120a, but may also be coupled to the wireless transceiver 120b). The energy source 125 may be any energy supply and/or storage device or system that may be configured to provide energy to the wireless transceivers 120, such as, for example, a terrestrial power grid, a solar power source, a battery, etc. While the communication links 145a, 145b are shown as direct communication lines, those skilled in the art will appreciate that various other components (not shown in FIG. 1) of wired and/or wireless infrastructure may form part of the communication links 145a, 145b, including one or more cables, routers, servers, transceivers, satellites, etc. The computing devices 140 may include any individual or array of computing devices known to those skilled in the art, and may be coupled directly to and/or located remote from the wireless transceivers 120.

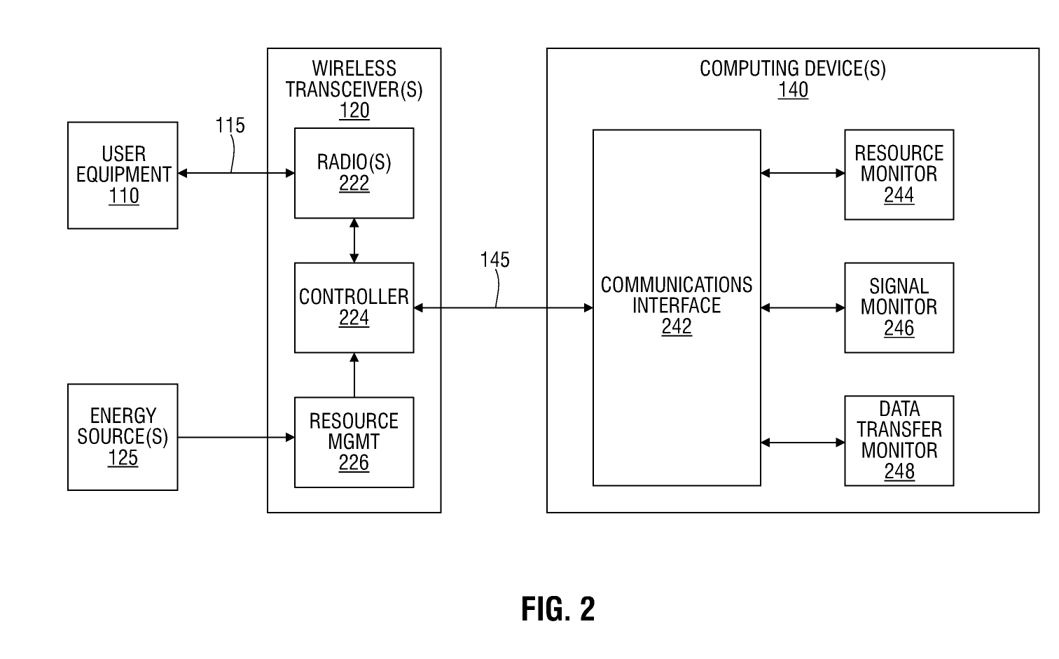

Having provided an overview of the wireless telecommunications system 100 in the context of FIG. 1, reference is now made to FIG. 2, which shows certain operations of the wireless telecommunications system 100, in accordance with an embodiment of the present disclosure. In particular, FIG. 2 illustrates an example embodiment of how functionality and corresponding components may be allocated among the UE 110, wireless transceivers 120, and the computing devices 140 to calculate costs of resources consumed to facilitate wireless telecommunications. Although more detailed aspects of how the system 100 calculates costs of facilitating wireless telecommunications are provided below in the context of FIGS. 4 and 5, FIG. 2 provides an overview of the functionality and component allocation. The arrangement of components depicted in FIG. 2 is provided by way of example and not limitation. Other arrangements of components and allocations of functionality are contemplated, for instance, with the UE 110 and/or wireless transceivers 120 including components that implement functionality shown in FIG. 2 as being implemented by the computing devices 140, or vice versa. However, in the example shown in FIG. 2, a majority of components and functionality are allocated to the computing devices 140 instead of to the UE 110 and the wireless transceivers 120, which decreases the amount of energy required to operate the components of the UE 110 and the wireless transceivers 120, and thus enables the components of the UE 110 and the wireless transceivers 120 to utilize a greater portion of the available energy than would be possible if more components and functionality were allocated to the UE 110 and/or the wireless transceivers 120. This increases usage time and capabilities of the UE 110 and the wireless transceivers 120 for implementing functionality and/or providing services for a given amount of available energy.

In addition to certain components that were introduced above in connection with FIG. 1, FIG. 2 shows that the wireless transceivers 120 include one or more radios 222, a controller 224, and a resource management module 226. The radios 222 may be configured to generate beams whereby wireless connections between the UE 110 and the wireless transceivers 120 may be established and data transmitted. The controller 224 may control the operations of the wireless transceiver 120 and, among other functions, cause the resource management module 226 to allocate energy to the radios 222 to facilitate wireless communications. The controller 224 may further collect or generate data regarding the amount of energy consumed by the radios and other components (not shown in FIG. 2) of the wireless transceivers 120 for facilitating each wireless communications session, and may provide the data to the computing devices 140. The controller 224 may further collect and/or generate data regarding the signal strength of the wireless connection between the UE 110 and the wireless transceivers 120, and may also provide this data to the computing devices 140. Additionally, the controller may collect and/or generate data regarding the type and/or amount of data transferred via the wireless connection between the UE 110 and the wireless transceivers 120, and also provide this data to the computing devices 140.

The computing devices 140 include a communications interface 242 configured to receive the various data and other communications from the wireless transceivers 120, and in turn provide notifications to the wireless transceivers 120 to be transmitted to the UE 110. The computing devices 140 may then relay, via the communications interface 242, the received data and other communications to an appropriate module, such as a resource monitor module 244, a signal monitor module 246, and a data transfer monitor 248. The resource monitor module 244 may monitor the amount of resources, including energy, wireless spectrum usage, etc., for each wireless connection established by the wireless transceivers 120, and may generate notifications regarding a cost of the resources used to facilitate each wireless connection to be relayed to the UE 110 associated with each wireless connection. The signal monitor module 246 may monitor the signal strength of each wireless connection established by the wireless transceivers 120, and may generate notifications regarding the signal strength and guidance for improving weak signals to be relayed to the UE 110 associated with each wireless connection. And the data transfer monitor module 248 may monitor the type and amount of data transferred during each wireless connection established by the wireless transceivers 120, and may generate notifications regarding the amount of data transferred and/or the cost of the data transfers for each wireless connection to be relayed to the UE 110 associated with each wireless connection.

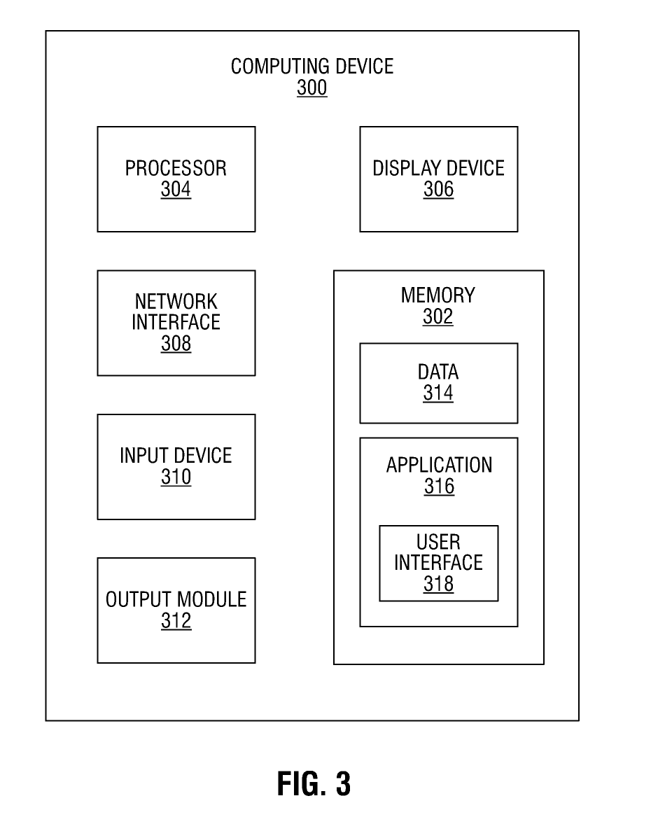

FIG. 3 is a schematic block diagram of a computing device 300 that may be employed in accordance with various embodiments described herein. Although not explicitly shown in FIG. 1 or FIG. 2, in some embodiments, the computing device 300, or one or more of the components thereof, may further represent one or more components (e.g., the computing device 140, the UE 110, components of the wireless transceiver 120, and/or the like) of the system 100. The computing device 300 may, in various embodiments, include one or more memories 302, processors 304, display devices 306, network interfaces 308, input devices 310, and/or output modules 312. The memory 302 includes non-transitory computer-readable storage media for storing data and/or software that is executable by the processor 304 and which controls the operation of the computing device 300. In embodiments, the memory 302 may include one or more solid-state storage devices such as flash memory chips. Alternatively, or in addition to the one or more solid-state storage devices, the memory 302 may include one or more mass storage devices connected to the processor 304 through a mass storage controller (not shown in FIG. 3) and a communications bus (not shown in FIG. 3). Although the description of computer readable media included herein refers to a solid-state storage, it should be appreciated by those skilled in the art that computer-readable storage media may be any available media that can be accessed by the processor 304. That is, computer readable storage media includes non-transitory, volatile and non-volatile, removable and non-removable media implemented in any method or technology for storage of information such as computer-readable instructions, data structures, program modules or other data. Examples of computer-readable storage media include RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which may be used to store the desired information and which can be accessed by computing device 300.

In some embodiments, the memory 302 stores data 314 and/or an application 316. In some aspects the application 316 includes a user interface component 318 that, when executed by the processor 304, causes the display device 306 to present a user interface, for example a graphical user interface (GUI) (not shown in FIG. 3). The network interface 308, in some embodiments, is configured to couple the computing device 300 and/or individual components thereof to a network, such as a wired network, a wireless network, a local area network (LAN), a wide area network (WAN), a cellular network, a Bluetooth network, the Internet, and/or another type of network. The input device 310 may be any device by means of which a user may interact with the computing device 300. Examples of the input device 310 include without limitation a mouse, a keyboard, a touch screen, a voice interface, a computer vision interface, and/or the like. The output module 312 may, in various embodiments, include any connectivity port or bus, such as, for example, a parallel port, a serial port, a universal serial bus (USB), or any other similar connectivity port known to those skilled in the art.

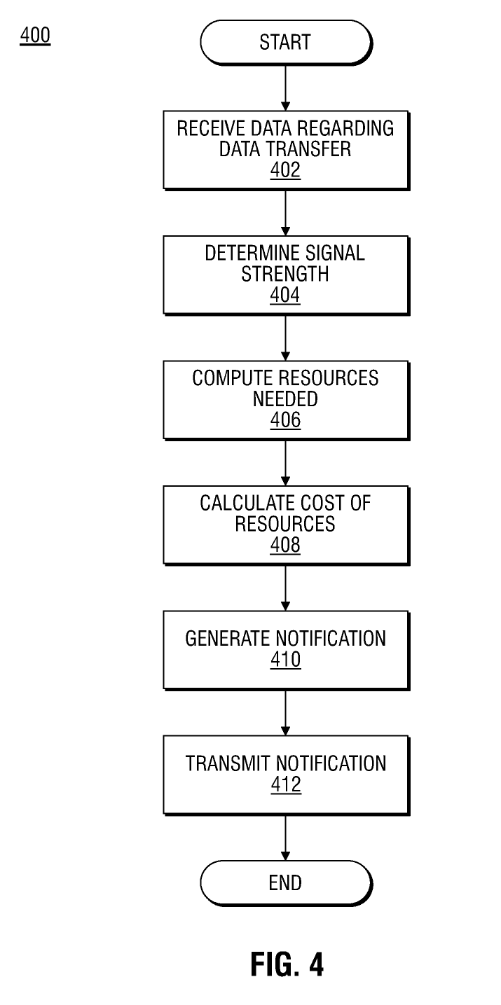

Turning now to FIG. 4, there is shown a flowchart depicting an illustrative method 400 for providing resource consumption-based notifications and/or billing information for wireless telecommunications from the perspective of the computing devices 140 of the system 100, in accordance with an embodiment of the present disclosure. As described above, the computing device 140 include various components, including processors, memories, and various other modules. As will be appreciated by those skilled in the art, the processes described below may be performed and/or executed by a variety of these components. As such, the description that follows will refer to the processes being performed by the computing devices 140, but those skilled in the art will recognize that one or more of the above-described components of the computing devices 140 are used by the computing devices 140 to perform and/or execute these processes. Further, those skilled in the art will recognize that the processes described below may be a sub-process forming part of a bigger process for facilitating wireless telecommunications and/or incentivizing efficient usage of wireless telecommunication resources, and thus various other processes and/or steps may be performed in addition to the below-described steps and processes. While the processes described below are organized into an illustrative ordered sequence of steps, those skilled in the art will appreciate that various of these steps may be performed in a different order or sequence, repeated, and/or omitted without departing from the scope of the present disclosure.

A process managing resource consumption of wireless telecommunications and/or providing resource consumption-based billing information for wireless telecommunications may start at block 402, where the computing devices 140 receive data regarding a data transfer. The data may include type and/or amount of data transferred via a wireless connection between the wireless transceiver 120 and the UE 110. The data may further include data regarding the wireless spectrum used to establish the wireless connection and/or the amount of time during which the wireless connection was established and/or data was transferred.

At block 404, the computing devices 140 determine a signal strength of the wireless connection. In embodiments, the data received at block 402 may further include data regarding a signal related to the wireless connection, and the computing devices 140 may determine the signal strength of the wireless connection based on the data regarding the signal related to the wireless connection.

Next, at block 406, the computing devices 140 compute an amount of resources needed to facilitate the wireless connection. The computation may be based on the data regarding the type and/or amount of data transferred, as received at block 402, and/or the signal strength of the wireless connection determined at block 404. The computation may further be based on the wireless spectrum used to establish the wireless connection, and the amount of time during which the wireless connection was established and/or data was transferred. For example, a wireless connection with a weaker signal strength will require more time, and thus more resources, to transfer a particular type and amount of data than a wireless connection with a stronger signal strength.

Then, at block 408, the computing devices 140 calculate a cost of the resources needed to facilitate the wireless connection. Thereafter, at block 410, the computing devices 140 generate a notification regarding one or more of the determined signal strength of the wireless connection and/or the cost of the resources needed to facilitate the wireless connection. The computing devices 140 then, at block 412, transmit the notification generated at block 410 to the UE 110 to be displayed to the user. In embodiments, the notification is first transmitted to the wireless transceivers 120 and then relayed to the UE 110.

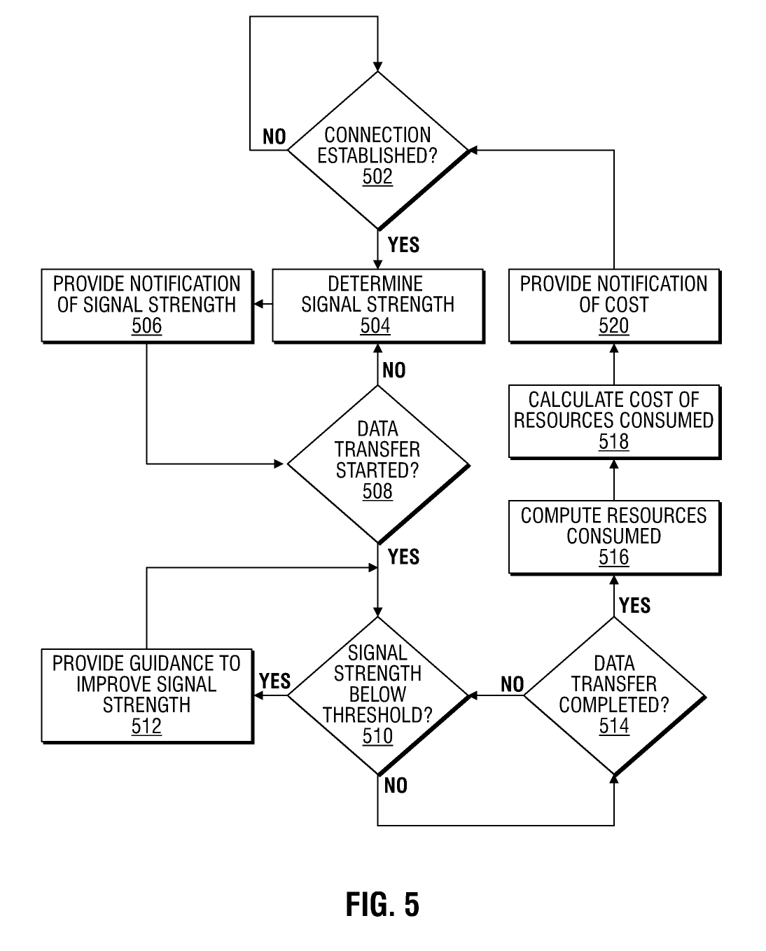

FIG. 5 is a flowchart showing an illustrative method 500 for facilitating wireless telecommunications, from the perspective of the computing devices 140, in accordance with an embodiment of the present disclosure. As described above with reference to FIG. 4, those skilled in the art will recognize that the processes described below may be a sub-process forming part of a bigger process for facilitating wireless telecommunications, and thus various other processes and/or steps may be performed in addition to the below-described steps and processes. While the processes described below are organized into an illustrative ordered sequence of steps, those skilled in the art will appreciate that various of these steps may be performed in a different order or sequence, repeated, and/or omitted without departing from the scope of the present disclosure.

The process 500 may begin at block 502, where it is determined whether a wireless connection has been established between the UE 110 and the wireless transceivers 120. If a wireless connection has not been established (“NO” at block 502), the method 500 loops back and repeats block 502 until it is determined that a connection has been established (“YES” at block 502), whereafter processing proceeds to block 504.

At block 504, a signal strength of the wireless connection between the UE 110 and the wireless transceivers 120 is determined. In embodiments, as described above, the wireless transceivers 120 provide data regarding the signal and/or signal strength of the wireless connection to the computing devices 140, and the computing devices 140 then determine the signal strength of the wireless connection. Thereafter, at block 506, the computing devices 140 generate and provide a notification regarding the signal strength to the UE 110 via the wireless transceivers 120. In embodiments, the notification is a textual notification indicating the signal strength of the wireless connection. In other embodiments, the notification is a graphical notification indicating the signal strength of the wireless connection. For example, the notification may be in the form of a color coded display element, such as color coded signal bars indicating the signal strength of the wireless connection. Then, processing proceeds to block 508.

At block 508, it is determined whether a data transfer via the wireless connection has started. In embodiments, the computing devices 140 may receive data regarding the wireless connection from the transceivers 120 and may determine whether the data transfer has started based on the data regarding the wireless connection. For example, the computing devices 140 may continuously or intermittently during the wireless connection receive data regarding the state of the wireless connection and a type and/or amount of data transferred via the wireless connection. If a data transfer has not started (“NO” at block 508), processing returns to block 504 where the signal strength of the wireless connection is again determined. Alternatively, if a data transfer has started (“YES”) at block 508, processing proceeds to block 510.

At block 510, it is determined whether the signal strength of the wireless connection is below one or more thresholds. For example, the computing devices 140 may determine whether the signal strength of the wireless connection determined at block 504 is below a threshold indicating that the signal strength is sufficient for data transfer. If it is determined that the signal strength is below the threshold (“YES” at block 510), processing proceeds to block 512, where the computing devices generate and provide a notification including guidance for improving the signal strength of the wireless connection to the UE 110 via the wireless transceivers 120. The guidance for improving the signal strength of the wireless connection may include textual, graphical, and/or audible instructions to change the location of the UE 110, if possible, such as by moving closer to the wireless transceivers 120 and/or to attempt to remove obstructions in the signal path between the UE 110 and the wireless transceivers 120 (e.g., if inside a structure to move outside, or if on a lower floor of a structure to move to an upper floor, if possible, etc.). Alternatively, if it is determined that the signal strength is above the threshold (“NO” at block 510), processing proceeds to block 514.

At block 514, it is determined whether the data transfer has been completed. For example, the computing devices 140 may determine whether the data transfer has been completed based on the data regarding the state of the wireless connection that is continuously or intermittently received from the wireless transceivers 120. If it is determined that the data transfer has not been completed (“NO” at block 514), processing returns to block 510, where it is again determined if the strength of the wireless connection is below one or more thresholds. Alternatively, if it is determined that the data transfer has been completed (“YES” at block 514), processing proceeds to block 516.

At block 516, the amount resources consumed to facilitate the data transfer is computed. For example, the computing devices 140 may compute the resources consumed to facilitate the data transfer based on the data regarding the state of the wireless connection and the type and amount of data transferred that is continuously or intermittently received from the wireless transceivers 120. In embodiments, the amount of resources consumed to facilitate the data transfer includes an amount of energy consumed to facilitate the data transfer. For example, the amount of energy consumed to facilitate the data transfer may be based on the signal strength of the wireless connection determined at block 504 and/or the wireless spectrum and time used during the data transfer.

Thereafter, at block 518, the computing devices 140 calculate a cost of the resources consumed to facilitate the data transfer. In embodiments, the cost of the resources consumed to facilitate the data transfer is based on a flat rate cost of resources, e.g. a flat rate cost per unit of energy consumed. In other embodiments, the cost of the resources consumed to facilitate the data transfer is further based on the time during which the data transfer occurred, whether the energy source 125 coupled to the wireless transceivers 120 was generating energy at the time of the data transfer, and/or an amount of energy remaining available in energy storage coupled to the wireless transceivers 120.

Then, at block 520, the computing devices 120 generate and provide a notification regarding the cost of the resources consumed to facilitate the data transfer, as calculated at block 518, to the UE 110 via the wireless transceivers 120. The notification regarding the cost of the resources may be displayed by the UE 110 to the user, and may include textual and/or graphical indications of the cost of the resources. Thereafter, processing returns to block 502.

In some embodiments, in addition to the signal strength determination performed by the computing devices 140 at block 504, and the guidance for increasing signal strength provided by the computing devices 140 at block 512, the UE 110 may also determine, such as via an application or subroutine, the signal strength of the wireless connection and provide additional guidance for improving the signal strength of the wireless connection. For example, the UE 110 may determine a location of the UE 110 (either entered by the user or automatically determined, such as via global positioning system (GPS) data and/or the signal strength of the wireless connection) and/or additional input from the user regarding potential obstructions in the signal path (e.g. if inside a structure or if in proximity to devices that may interfere with wireless signals), whether the UE 110 is in a favorable or unfavorable location for wireless communications, and may provide guidance for improving the signal strength of the wireless connection based on the determination. In some embodiments, the UE 110, such as via an application or subroutine, may generate or receive a map of an area surrounding the UE 110, determine a location of the UE 110 and/or the wireless transceivers 120, determine whether there are structures or other objects located in the signal path, and provide guidance for improving the signal strength of the wireless connection based on the determinations. In further embodiments, the UE 110, such as via an application or subroutine, may identify, based on the location of the wireless transceivers 120, areas on the map where the signal strength of the wireless connection will be good, and provide guidance regarding locations with good signal strength.

As can be appreciated in view of the present disclosure, the systems and methods described herein provide advancements in wireless telecommunications resource consumption management and/or billing processes that may be used to incentivize more efficient resource consumption behavior by users of wireless telecommunications systems, and may thus increase the service quality of the incentivized users as well as other users of the same wireless telecommunications systems. The embodiments disclosed herein are examples of the present systems and methods and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present information systems in virtually any appropriately detailed structure. Like reference numerals may refer to similar or identical elements throughout the description of the figures.

The phrases “in an embodiment,” “in embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems and/or methods described herein may utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms. In example embodiments that employ a combination of multiple controllers and/or multiple memories, each function of the systems and/or methods described herein can be allocated to and executed by any combination of the controllers and memories.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

Any of the herein described methods, programs, algorithms or codes may be contained on one or more non-transitory computer-readable or machine-readable media or memory. The term “memory” may include a mechanism that provides (in an example, stores and/or transmits) information in a form readable by a machine such a processor, computer, or a digital processing device. For example, a memory may include a read only memory (ROM), random access memory (RAM), magnetic disk storage media, optical storage media, flash memory devices, or any other volatile or non-volatile memory storage device. Code or instructions contained thereon can be represented by carrier wave signals, infrared signals, digital signals, and by other like signals.

The foregoing description is only illustrative of the present systems and methods. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

1. A system for managing resource consumption of wireless communications, the system comprising:
a wireless transceiver;
a wireless communications device in wireless communication with the wireless transceiver;
a computing device communicatively coupled to the wireless transceiver, the computing device including a processor and a memory storing instructions which, when executed by the processor, cause the computing device to:
receive data regarding a data transfer between the wireless transceiver and the wireless communications device,
determine a signal strength of a connection between the wireless transceiver and the wireless communications device;
determine whether the determined signal strength meets a threshold value indicating whether the determine signal strength is insufficient for data transfer,
based on the determination of whether the signal strength meets the threshold value, send a notification including guidance for improving the determined signal strength to the wireless communications device.
based on the determination of whether the determined signal strength meets the threshold value, compute an amount of resources associated with the data transfer based at least in part on the determined signal strength,
generate a notification based on the amount of resources, and
transmit the notification to the wireless communications device.

2. The system according to claim 1, wherein the instructions, when executed by the processor, further cause the computing device to calculate a cost of the amount of resources associated with the data transfer.

3. The system according to claim 2, wherein the instructions, when executed by the processor, further cause the computing device to provide a notification to the wireless communications device regarding the calculated cost of the amount of resources associated with the data transfer.

4. The system according to claim 1, wherein the resources include energy.

5. The system according to claim 4, further comprising an energy source coupled to the wireless transceiver, the energy source being configured to provide energy to the wireless transceiver.

6. The system according to claim 5, wherein the instructions, when executed by the processor, further cause the computing device to:
receive data regarding an amount of energy consumed to facilitate the data transfer,
wherein the computation of the amount of resources associated with the data transfer is at least partially based on the data regarding the amount of energy consumed to facilitate the data transfer.

7. The system according to claim 6, wherein the instructions, when executed by the processor, further cause the computing device to provide a notification to the wireless communications device regarding the amount of energy consumed to facilitate the data transfer.

8-10. (canceled)

11. The system according to claim 1, wherein the notification is a textual message.

12. The system according to claim 1, wherein the notification is a graphical element.

13. The system according to claim 1, wherein the notification is color-coded.

14. The system according to claim 13, wherein the notification includes color-coded signal bars.

15. The system according to claim 1, wherein the notification includes guidance for improving the signal strength of the connection.

16. The system according to claim 1, wherein the notification is provided during the data transfer.

17. The system according to claim 1, wherein the notification is provided after the data transfer.

18. The system according to claim 1, wherein the data regarding a data transfer includes at least one of:
an amount of data transferred;
a data transfer rate;
a duration of the data transfer; or
a type of data transfer.

19. A method for managing resource consumption of wireless communications, the method comprising:
receiving data regarding a data transfer between a wireless transceiver and a wireless communications device;
determining a signal strength of a connection between the wireless transceiver and the wireless communications device;
determining whether the determine signal strength meets a threshold value indicating whether the determine signal strength is insufficient for data transfer;
based on the determination of whether the signal strength meets the threshold value, sending a notification including guidance for improving the determined signal strength to the wireless communications device.
based on the determination of whether the signal strength meets the threshold value, computing an amount of resources associated with the data transfer based at least in part on the determined signal strength;
generating a notification based on the amount of resources; and
transmitting the notification to the wireless communications device.

20. A non-transitory computer-readable storage medium storing a program for managing resource consumption of wireless communications, the program including instructions which, when executed by a processor, cause a computing device to:
receive data regarding a data transfer between a wireless transceiver and a wireless communications device;
determine a signal strength of a connection between the wireless transceiver and the wireless communications device;
determine whether the determine signal strength meets a threshold value indicating whether the determine signal strength is insufficient for data transfer;
based on the determination of whether the signal strength meets the threshold value, send a notification including guidance for improving the determined signal strength to the wireless communications device;
based on the determination of whether the signal strength meets the threshold value, compute an amount of resources associated with the data transfer based at least in part on the determined signal strength;
generate a notification based on the amount of resources; and
transmit the notification to the wireless communications device.

21. The system of claim 1, wherein the instructions, when executed by the processor, further cause the computing device to, after sending the notification, determine an updated signal strength of the connection between the wireless transceiver and the wireless communications device, and wherein the amount of resources is further computed based on the updated signal strength.

22. The system of claim 21, wherein the instructions, when executed by the processor, further cause the computing device to, after sending the notification, determine that the updated signal strength meets the threshold value.
